(19) United States
(12) Patent Application Publication
(10) Pub. No.: US 2016/0328738 A1
(43) Pub. Date: Nov. 10, 2016

(54) SYSTEM AND METHOD FOR PROVIDING OFF-VIEWPORT THIRD PARTY CONTENT

(71) Applicant: Google Inc., Mountain View, CA (US)

(72) Inventors: Yifang Liu, Redwood City, CA (US); Andy Chiu, Redwood City, CA (US)

(21) Appl. No.: 14/313,180

(22) Filed: Jun. 24, 2014

(51) Int. Cl. G06Q 30/02

(52) U.S. Cl. CPC G06Q 30/0242

(57) ABSTRACT

According to at least one aspect, a data processing system and method for providing off-viewport third party content include obtaining an in-viewport performance data set including a plurality of impressions and corresponding user interaction performance measures associated with a set of third-party content items. The data processing system can be configured to determine for each impression associated with a first map viewport a second map viewport smaller than the first map viewport by a respective zoom level. The data processing system can generate a training data set including, the plurality of impressions, the corresponding plurality of user interaction performance values and indications of the corresponding zoom levels. A user interaction predictive model can be trained using the generated training data set and the trained user interaction predictive model can be used to select third party content items for presentation with respective second map viewports as off-viewport third-party content items.

### BACKGROUND

In a networked environment, such as the Internet or other networks, first-party content providers can provide information for public presentation on resources, for example webpages, documents, applications, and/or other resources. The first-party content can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. For example, the third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). Thus, a person viewing a resource can access the first-party content that is the subject of the resource as well as the third-party content that may or may not be related to the subject matter of the resource.

### SUMMARY

Implementations described herein relate to providing location-based third party content for presentation outside a map viewport. In particular, implementations described herein relate to generating and employing a predictive model for providing off-viewport third party content.

One implementation relates to a method for providing off-viewport third party content. The method includes obtaining an in-viewport performance data set including a plurality of impressions and a corresponding plurality of user interaction performance measures associated with a respective set of third-party content items. Each impression is associated with a third-party content item of the set of third party content items presented for display in a respective first map viewport associated with a first resolution level. For each impression a second map viewport smaller than the first map viewport by a respective zoom level is determined. The second map viewport is determined such that a location within the first map viewport associated with the third-party content item is outside the second map viewport. The method includes generating a training data set including the plurality of impressions, the corresponding plurality of user interaction performance values and indications of the corresponding zoom levels. A user interaction predictive model is trained using the generated training data set, and the trained user interaction predictive model is employed to select third party content items for presentation with respective second map viewports as off-viewport third-party content items.

Another implementation relates to a system for providing off-viewport third party content. The system may include one or more processors and one or more storage devices. The one or more storage devices includes instructions that cause the one or more processors to perform several operations. The operations include obtaining an in-viewport performance data set including a plurality of impressions and a corresponding plurality of user interaction performance measures associated with a respective set of third-party content items. Each impression is associated with a third-party content item of the set of third party content items presented for display in a respective first map viewport associated with a first resolution level. For each impression, the system determines a second map viewport smaller than the first map viewport by a respective zoom level such that a location within the first map viewport associated with the third-party content item is outside the second map viewport. The system can generate a training data set including, the plurality of impressions, the corresponding plurality of user interaction performance values and indications of the corresponding zoom levels. The system can be configured to train a user interaction predictive model using the generated training data set, and use the trained user interaction predictive model to select third party content items for presentation with respective second map viewports as off-viewport third-party content items.

Yet a further implementation relates to a computer readable storage device storing instructions that, when executed by one or more processors, cause the one or more processors to perform several operations. The operations may include obtaining an in-viewport performance data set including a plurality of impressions and a corresponding plurality of user interaction performance measures associated with a respective set of third-party content items. Each impression is associated with a third-party content item of the set of third party content items presented for display in a respective first map viewport associated with a first resolution level. For each impression, a second map viewport smaller than the first map viewport by a respective zoom level is determined such that a location within the first map viewport associated with the third-party content item is outside the second map viewport. A training data set including, the plurality of impressions, the corresponding plurality of user interaction performance values and indications of the corresponding zoom levels can be generated. A user interaction predictive model can be trained using the generated training data set, and the trained user interaction predictive model can be used to select third party content items for presentation with respective second map viewports as off-viewport third-party content items.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an implementation of a system of providing information via a computer network;

FIG. 2 shows a map interface illustrating presentation of geographic map data with location-related third party content, according to a described implementation;

FIG. 3 shows a flowchart illustrating a process of generating and using a user interaction predictive model for providing third party content to be presented off map viewports according to a described implementation;

FIG. 4 shows a graphical diagram illustrating determination of a second map viewport based on a first map viewport and a location associated with a third party content item within the first map viewport according to a described implementation;

FIG. 5 is a flowchart illustrating a process of generating and using a calibrated user interaction predictive model to select off-viewport third party content items according to a described implementation; and

FIG. 6 is a block diagram depicting one implementation of a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways as the described concepts are not limited to any particular manner of implementation. Examples of specific implementations and applications are provided primarily for illustrative purposes.

A computing device (e.g., a client device) can view a resource, such as a webpage, a document, an application, a geographic map, etc. In some implementations, the computing device may access the resource via the Internet by communicating with a server, such as a webpage server, corresponding to that resource. The resource includes first-party content that is the subject of the resource from a first-party content provider and may also include additional third-party provided content, such as advertisements or other content. In one implementation, responsive to receiving a request to access a webpage, a webpage server and/or a client device can communicate with a data processing system, such as a content item selection system, to request a content item to be presented with the requested webpage, such as through the execution of code of the resource to request a third-party content item to be presented with the resource. The content item selection system can select a third-party content item and provide data to effect presentation of the content item with the requested webpage on a display of the client device. In some instances, the content item is selected and served with a resource associated with a search query response. For example, a search engine may return search results on a search results webpage and may include third-party content items related to the search query in one or more content item slots of the search results webpage.

The computing device (e.g., a client device) may also be used to view or execute an application, such as a mobile application. The application may include first-party content that is the subject of the application from a first-party content provider and may also include additional third-party provided content, such as advertisements or other content. In one implementation, responsive to use of the application, a resource server and/or a client device can communicate with a data processing system, such as a content item selection system, to request a content item to be presented with a user interface of the application and/or otherwise. The content item selection system can select a third-party content item and provide data to effect presentation of the content item with the application on a display of the client device.

In some instances, a device identifier may be associated with the client device. The device identifier may be a randomized number associated with the client device to identify the device during subsequent requests for resources and/or content items. In some instances, the device identifier may be configured to store and/or cause the client device to transmit information related to the client device to the content item selection system and/or resource server (e.g., values of sensor data, a web browser type, an operating system, historical resource requests, historical content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For example, a third-party content provider may place a bid in the auction that corresponds to an agreement to pay a certain amount of money if a user interacts with the provider's content item (e.g., the provider agrees to pay $3 if a user clicks on the provider's content item). In other examples, a third-party content provider may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system uses content item interaction data to determine the performance of the third-party content provider's content items. For example, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In some instances, one or more performance metrics for the third-party content items may be determined and indications of such performance metrics may be provided to the third-party content provider via a user interface for the content item management account. For example, the performance metrics may include a cost per impression (CPI) or cost per thousand impressions (CPM), where an impression may be counted, for example, whenever a content item is selected to be served for presentation with a resource. In some instances, the performance metric may include a click-through rate (CTR), defined as the number of clicks on the content item divided by the number of impressions. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics may be used.

In some instances, a webpage or other resource (such as, for example, an application) includes one or more content item slots in which a selected and served third-party content item may be displayed. The code (e.g., JavaScript®, HTML, etc.) defining a content item slot for a webpage or other resource may include instructions to request a third-party content item from the content item selection system to be presented with the webpage. In some implementations, the code may include an image request having a content item request URL that may include one or more parameters (e.g.,/page/contentitem?devid=abc123&devnfo=A34r0). Such parameters may, in some implementations, be encoded strings such as “devid=abc123” and/or “devnfo=A34r0.”

The selection of a third-party content item to be served with the resource by a content item selection system may be based on several influencing factors, such as a predicted click through rate (pCTR), a predicted conversion rate (pCVR), a bid associated with the content item, etc. Such influencing factors may be used to generate a value, such as a score, against which other scores for other content items may be compared by the content item selection system through an auction.

During an auction for a content item slot for a resource, such as a webpage, several different types of bid values may be utilized by third-party content providers for various third-party content items. For example, an auction may include bids based on whether a user clicks on the third-party content item, whether a user performs a specific action based on the presentation of the third-party content item, whether the third-party content item is selected and served, and/or other types of bids. For example, a bid based on whether the third-party content item is selected and served may be a lower bid (e.g., $0.005) while a bid based on whether a user performs a specific action may be a higher bid (e.g., $5). In some instances, the bid may be adjusted to account for a probability associated with the type of bid and/or adjusted for other reasons. For example, the probability of the user performing the specific action may be low, such as 0.2%, while the probability of the selected and served third-party content item may be 100% (e.g., the selected and served content item will occur if it is selected during the auction, so the bid is unadjusted). Accordingly, a value, such as a score or a normalized value, may be generated to be used in the auction based on the bid value and the probability or another modifying value. In the prior example, the value or score for a bid based on whether the third-party content item is selected and served may be $0.005*1.00=0.005 and the value or score for a bid based on whether a user performs a specific action may be $5*0.002=0.01. To maximize the income generated, the content item selection system may select the third-party content item with the highest value from the auction. In the foregoing example, the content item selection system may select the content item associated with the bid based on whether the user performs the specific action due to the higher value or score associated with that bid.

Once a third-party content item is selected by the content item selection system, data to effect presentation of the third-party content item on a display of the client device may be provided to the client device using a network.

In some instances, location related third party content items can be presented with a map viewport representing geographic data. Typically, only third party content items associated with locations within the map viewport (referred to herein as in-viewport) are presented. In the current disclosure, processes and data processing systems enable providing third party content items to be presented off-viewport with geographic data are. An off-viewport third party content item is associated with a location that falls outside the map viewport enclosing the geographic data presented to a user. One of the challenges raised by off-viewport third party content is that user interaction predictive models for in-viewport third party content do not take into account some factors associated with off-viewport third party content that can affect the user's response to presented off-viewport third party content items.

While the foregoing has provided an overview of providing off-viewport third party content with requested geographic data, processes and computer systems described in the current disclosure allow generating a user interaction predictive model for off-viewport third party content based on in-viewport performance data. The generated user interaction predictive model can be deployed for use in selecting off-viewport third party content items to be provided for presentation with geographic data. Collected real off-viewport performance data can then be used to construct a calibration user interaction predictive model for off-viewport third party content.

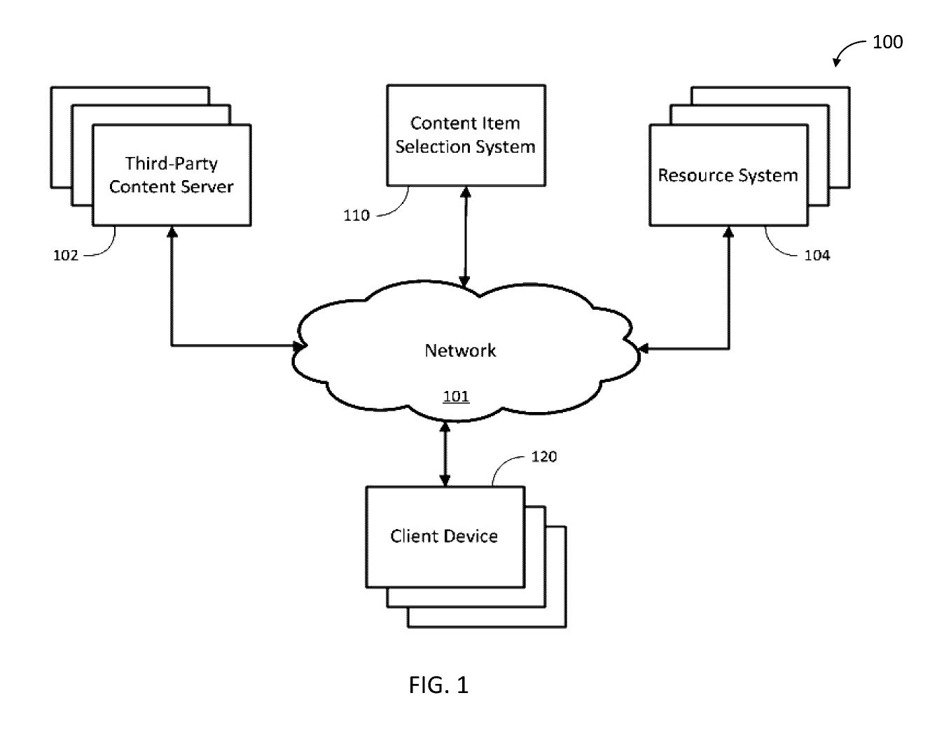

FIG. 1 is a block diagram of an implementation of a system 100 for providing information via at least one computer network such as the network 101. The network 101 may include a local area network (LAN), wide area network (WAN), a telephone network, such as the Public Switched Telephone Network (PSTN), a wireless link, an intranet, the Internet, or combinations thereof. The system 100 can also include at least one data processing system, such as a content item selection system 110. The content item selection system 110 can include at least one logic device, such as a computing device having a data processor, to communicate via the network 101, for example with a resource server 104, a client device 120, and/or a third-party content server 102. The content item selection system 110 can include one or more data processors, such as a content placement processor, configured to execute instructions stored in a memory device to perform one or more operations described herein. In other words, the one or more data processors and the memory device of the content item selection system 110 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processor may process instructions and output data to effect presentation of one or more content items to the resource server 104 and/or the client device 120. In addition to the processing circuit, the content item selection system 110 may include one or more databases configured to store data. The content item selection system 110 may also include an interface configured to receive data via the network 101 and to provide data from the content item selection system 110 to any of the other devices on the network 110. The content item selection system 110 can include a server, such as an advertisement server or otherwise.

The client device 120 can include one or more devices such as a computer, laptop, desktop, smart phone, tablet, personal digital assistant, set-top box for a television set, a smart television, or server device configured to communicate with other devices via the network 101. The device may be any form of portable electronic device that includes a data processor and a memory. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

The client device 120 can execute a software application (e.g., a web browser or other application) to retrieve content from other computing devices over the network 101. Such an application may be configured to retrieve first-party content from a resource server 104. In some cases, an application running on the client device 120 may itself be first-party content (e.g., a game, a media player, etc.). In one implementation, the client device 120 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 101 referred to by the URL address (e.g., a resource server 104). The other device may then provide web page data, geographic map data, and/or other data to the client device 120, which causes visual indicia to be displayed by the display of the client device 120. Accordingly, the browser window displays the retrieved first-party content, such as web pages from various websites, to facilitate user interaction with the first-party content.

The resource server 104 can include a computing device, such as a server, configured to host a resource, such as a web page or other resource (e.g., articles, comment threads, music, video, graphics, search results, information feeds, geographic map data, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide resource data or other content (e.g., text documents, PDF files, and other forms of electronic documents) to the client device 110. In one implementation, the client device 120 can access the resource server 104 via the network 101 to request data to effect presentation of a resource of the resource server 104.

One or more third-party content providers may have third-party content servers 102 to directly or indirectly provide data for third-party content items to the content item selection system 110 and/or to other computing devices via network 101. The content items may be in any format that may be presented on a display of a client device 120, for example, graphical, text, image, audio, video, etc. The content items may also be a combination (hybrid) of the formats. The content items may be banner content items, interstitial content items, pop-up content items, rich media content items, hybrid content items, Flash® content items, cross-domain iframe content items, etc. The content items may also include embedded information such as hyperlinks, metadata, links, machine-executable instructions, annotations, etc. In some instances, the third-party content servers 102 may be integrated into the content item selection system 110 and/or the data for the third-party content items may be stored in a database of the content item selection system 110.

In one implementation, the content item selection system 110 can receive, via the network 101, a request for a content item to present with a resource. The received request may be received from a resource server 104, a client device 120, and/or any other computing device. The resource server 104 may be owned or ran by a first-party content provider that may include instructions for the content item selection system 110 to provide third-party content items with one or more resources of the first-party content provider on the resource server 104. In one implementation, the resource may include a web page, geographic map data, and/or the like. The client device 120 may be a computing device operated by a user (represented by a device identifier), which, when accessing a resource of the resource server 104, can make a request to the content item selection system 110 for content items to be presented with the resource, for instance. The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords of the content of the requested resource, text of the content of the resource, a title of the resource, a category of the resource, a type of the resource, etc.). The information that the content item selection system 110 receives can include a HyperText Transfer Protocol (HTTP) cookie which contains a device identifier (e.g., a random number) that represents the client device 120. In some implementations, the device information and/or the resource information may be appended to a content item request URL (e.g., contentitem.item/page/contentitem?devid=abc123&devnfo=A34r0). In some implementations, the device information and/or the resource information may be encoded prior to being appended the content item request URL. The requesting device information and/or the resource information may be utilized by the content item selection system 110 to select third-party content items to be served with the requested resource and presented on a display of a client device 120.

In some instances, a resource of a resource server 104 may include a search engine feature. The search engine feature may receive a search query (e.g., a string of text) via an input feature (an input text box, etc.). The search engine may search an index of documents (e.g., other resources, such as web pages, etc.) for relevant search results based on the search query. The search results may be transmitted as a second resource to present the relevant search results, such as a search result web page, on a display of a client device 120. The search results may include web page titles, hyperlinks, etc. One or more third-party content items may also be presented with the search results in a content item slot of the search result web page. Accordingly, the resource server 104 and/or the client device 120 may request one or more content items from the content item selection system 110 to be presented in the content item slot of the search result web page. The content item request may include additional information, such as the user device information, the resource information, a quantity of content items, a format for the content items, the search query string, keywords of the search query string, information related to the query (e.g., geographic location information and/or temporal information), etc. In some implementations, a delineation may be made between the search results and the third-party content items to avert confusion.

In some implementations, the third-party content provider may manage the selection and serving of content items by the content item selection system 110. For example, the third-party content provider may set bid values and/or selection criteria via a user interface that may include one or more content item conditions or constraints regarding the serving of content items. A third-party content provider may specify that a content item and/or a set of content items are to be selected and served for user devices 120 having device identifiers associated with a certain geographic location or region, a certain language, a certain operating system, a certain web browser, etc. In another implementation, the third-party content provider may specify that a content item or set of content items are to be selected and served when the resource, such as a web page, document, etc., contains content that matches or is related to certain keywords, phrases, etc. The third-party content provider may set a single bid value for several content items, set bid values for subsets of content items, and/or set bid values for each content item. The third-party content provider may also set the types of bid values, such as bids based on whether a user clicks on the third-party content item, whether a user performs a specific action based on the presentation of the third-party content item, whether the third-party content item is selected and served, and/or other types of bids.

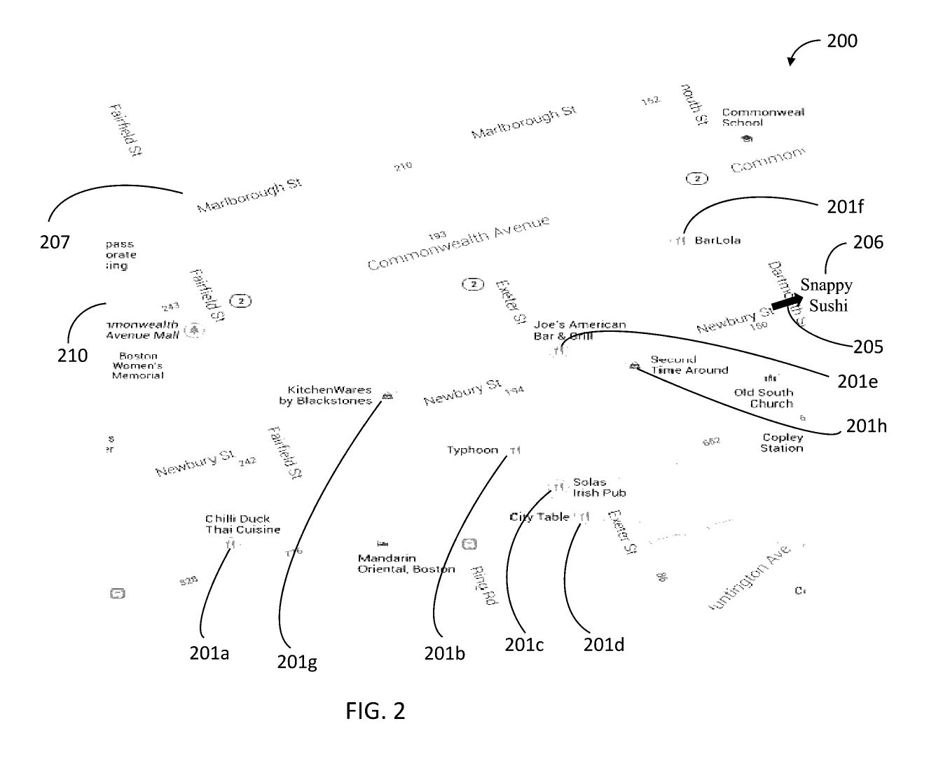

While the foregoing has provided an overview of a system 100 for selecting and serving content items to client devices 120, examples of presenting third party content items with geographic map data will now be described in reference to FIG. 2. Third party content can be provided and presented with requested map data.

FIG. 2 shows a map interface 200 illustrating presentation of geographic map data with location-related third party content, according to a described implementation. The map interface 200 includes a map viewport 210 including geographic map data 207. The map interface 200 also includes a plurality of marker icons 201a-201h (generally 201) and a projection marker 205. Although only eight marker icons 201 are depicted in FIG. 2, it should be understood that any number of marker icons 201 may be displayed.

The map viewport 210 represents a window defining the boundaries of the geographic map data 207. The geographic map data 207 is typically a visual representation of a geographic area at a given resolution level. The visual representation can include a graphical representation of geographical map, a satellite photo, a photo taken at a relatively high altitude, the like, or combinations thereof. In general, the geographic map data 207 can be presented at different resolution levels. Also, a client device 120 displaying the map interface 200 can cause the resolution level associated with the presented geographical map data 207 to change. In some implementations, as the resolution level associated with map viewport 210 increases the geographical area represented by the geographical map data 207 decreases and vice versa.

A plurality of marker icons 201a-201h, also referred to herein either individually or collectively as marker icon(s) 201, may be plotted, or augmented, on top of the geographical map data 207. Each marker icon 201 may be indicative of a location associated with a respective third party content item. The third party content items associated with the icon markers 201a-201f may be advertisement content items associated with restaurants. The third party content items associated with the icon markers 201g-201h may be advertisement content items associated with shopping stores or centers. In some implementations, information related to a third party content item can be presented in association with the respective icon marker 201. In some implementations, such information is presented within a list presented with the viewport 210. In other implementations, the information is presented within pop-up windows, collouts, or other pop-up objects. In some implementations, the icon markers 201 can be selectable. Upon an icon marker 201 being selected, a pop-up object including information related to a respective third party content item can be presented within or outside the map viewport 210. The information related to third party content items can include text, images, video, graphics, hyperlinks, other types of content, or combinations thereof

The location associated with each of the marker icons 201a-201h is within the geographical area presented by the geographical map data 207 enclosed within the map viewport 210. Herein, the third party content items associated with locations within the geographical area presented within the map viewport 210 such as the third party content items associated with the marker icons 201a-201h are referred to as in-viewport third party content items. In existing map interfaces, usually only in-viewport third party content items are presented. As such, the third party content items presented with a given map viewport usually depend on the resolution level of that map viewport.

In-viewport representation of third party content items can be convenient in the sense it provides a clear indication of the locations associated with the presented third party content items. However, presenting only in-viewport third party content items can unnecessarily restrict the scope of displayed third party content items. A map can be presented at a relatively high resolution level to provide a clear visual description of a respective geographic area, to provide detailed visual driving directions, or due to settings of a an application configured to handle geographical map data 207. Also, a user or a respective client device 120 can select to present geographical map data 207 at a relatively high resolution level. In such cases, limiting the scope of third party content items to be presented with the map by the map viewport 210 and the respective resolution level may not properly serve users and third party content providers. For instance, a third party content item of great interest to a user may not be presented just because the corresponding location falls outside the map viewport 210.

In some implementations, third party content items associated with locations outside the map viewport 210, also referred to herein as off-viewport third party content items, can be presented in the map interface 200. The projective marker 205 is an illustrative implementation of presenting an off-viewport content item. In the map interface 200 shown in FIG. 2, the projective marker 205 is indicative of a third party content item associated with a sushi restaurant. The projective marker 205 includes an arrow pointing to the location associated with the respective off-viewport third party content item. The projective marker 205 can be placed inside, outside, or on the boundary of the map viewport 210 at a point that is closest to the location associated with the respective off-viewport third party content item.

In some implementations, the projective marker 205 can be selectable with information related to the off-viewport third party content item being presented upon selection of the projective marker 205. The information related to the off-viewport third party content item can be presented within a pop-up object, a media content item, a web page, or the like upon selection of the projective marker 205. In some implementations, the information related to the off-viewport third party content item can be presented in a list presented with the map viewport 210. In some implementations, different colors or different formats can be used to represent information related to in-viewport and off-viewport third party content items. The information related to off-viewport third party content items can include text, images, video, graphics, hyperlinks, other types of content, or combinations thereof. Also, other information such as the text data 206 can be presented with the projective marker 205 in or next to the map viewport 210. The text data 206 can include a name, a brief description, a hyperlink, a selectable icon, an indication of a distance to the location associated with the off-viewport third party content item, and/or the like. The distance to the location associated with the off-viewport third party content item can be indicated based on a reference location such as the location associated with the center of the map viewport 210 or a location provided by or associated with a user. The distance can be indicated in terms of a distance measure or travel time such as travel time by car, bicycle, foot, or other means of transportation. In some implementations, only the text data 206 (without the projective marker 205) is used for presenting the off-viewport third party content item. In some other implementations, other representations (other than the projective marker 205 and/or the text data 206) can be used to present off-viewport third party content items.

While off-viewport third party content extends the scope of third party content that can be presented with maps, it presents a challenge in terms of predicting user interaction with third party content items to be presented as off-viewport. In some implementations, when map-based content is requested by a client device 120 from a resource server 104 (all shown in FIG. 1), the content item selection system 110 (shown in FIG. 1) can be caused to select third party content items to be provided for presentation with the requested map-based content. In some implementations, the content item selection system 110 is configured select in-viewport and off-viewport third party content items. The content item selection system 110 is configured to employ a user interaction predictive model in selecting third party content items to be provided for presentation with the map-based content. The user interaction predictive model, also referred to herein as user relevance predictive model, can include a probabilistic model for predicting the likelihood of user interaction with a third party content item presented with requested map-based content. The user interaction predictive model can include a predictive click through rate (pCTR) model, a predictive conversion rate (pCVR) model, or any other model for predicting user interaction with third party content item to be presented with a requested resource.

In systems serving map-based content to users such as the system 100 (shown in FIG. 1), in-view presentation has been commonly used to provide and present third party content with requested map-based content. Performance data for in-viewport third party content indicative of number of impressions, click through rate (CTR), conversion rate (CVR), and/or other performance metrics may be recorded and used to enhance the user interaction predictive models used (for instance by the content item selection system 110 shown in FIG. 1) to select third party content items for in-viewport presentation with map-based content.

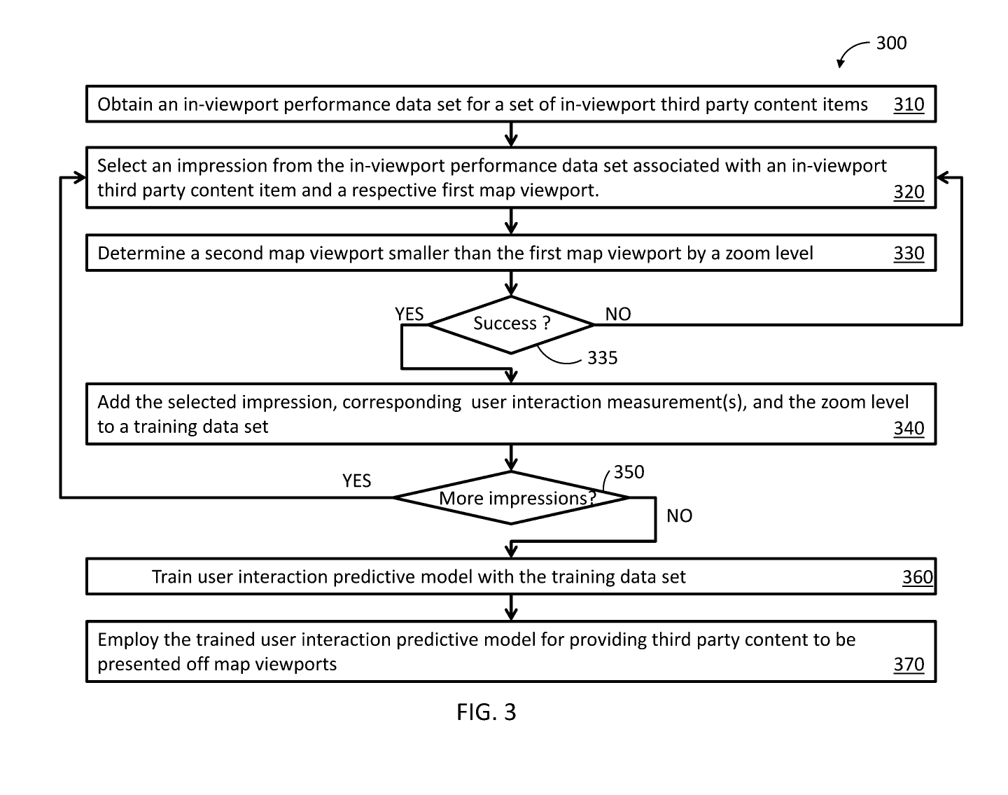

For off-viewport third party content items, a challenges presents itself with regard to forming user interaction predictive models such as pCTR, pCVR, and/or the like for use in selection off-viewport third party content to be provided with map-based content. A user interaction predictive model can be configured to provide prediction metrics of the likelihood an off-viewport third party content would trigger user interaction if presented off-viewport with map-related data. When used (for instance by the content item selection system 110 shown in FIG. 1) to select third party content items for presentation off-viewport with map-related content, the user interaction model would affect the outcome of resulting impressions and consequently the performances of the different third party content items. In other words, the user interaction predictive model plays a significant role in enhancing the overall performance of off-viewport third party content and increasing income generated from off-viewport third party content items. In the following, processes for generating and using a user interaction predictive model for off-viewport third party content are described in relation to FIGS. 3-5.

FIG. 3 shows a flowchart illustrating a process 300 of generating and using a user interaction predictive model for providing third party content to be presented off map viewports according to a described implementation. In brief overview, the process 300 includes obtaining a performance data set for a set of in-viewport third party content items (stage 310), selecting performance information associated with an in-viewport third party content item and a respective first map viewport (stage 320), determining a second map viewport based on the first map viewport and a zoom level(stage 330), if the second map viewport is successfully determined (decision block 335), adding the performance information and an indication of the zoom level to a training data set (stage 340), looping through stages 320-340 until the whole performance data set is processed (decision block 350), training the user interaction predictive model with the training data set obtained by looping through the stages 320-340 (stage 360), and employing the trained user interaction predictive model for selecting and providing off-viewport third party content items (370).

The process 300 can be executed by a computer device of the system 100 such as a server or processor associated with the content item selection system 110, a resource server 104, a third party content server 102, or any other device coupled to the system 100. The process 300 includes obtaining a performance data set for a set of in-viewport third party content items (stage 310). The performance data set can include performance measurements such as impressions and indications of recorded user interaction measurements for a set of third party content items used for presentation as in-viewport with map-related data. User interaction measurements can be provided in terms of click through rate (CTR) values, conversion rate (CVR) values, or any other performance metrics known to a person of ordinary skill in the art. In some implementations, an impression can represent a number of times a third party content item has been presented with map related data. In some implementations, an impression can represent a number of times a third party content item has been presented within a given map viewport associated with a respective resolution level. In some implementations, the performance data set can be collected by a computer device of the system 100 such as a server or processor associated with the content item selection system 110, a resource server 104, a third party content server 102, or any other device coupled to the system 100.

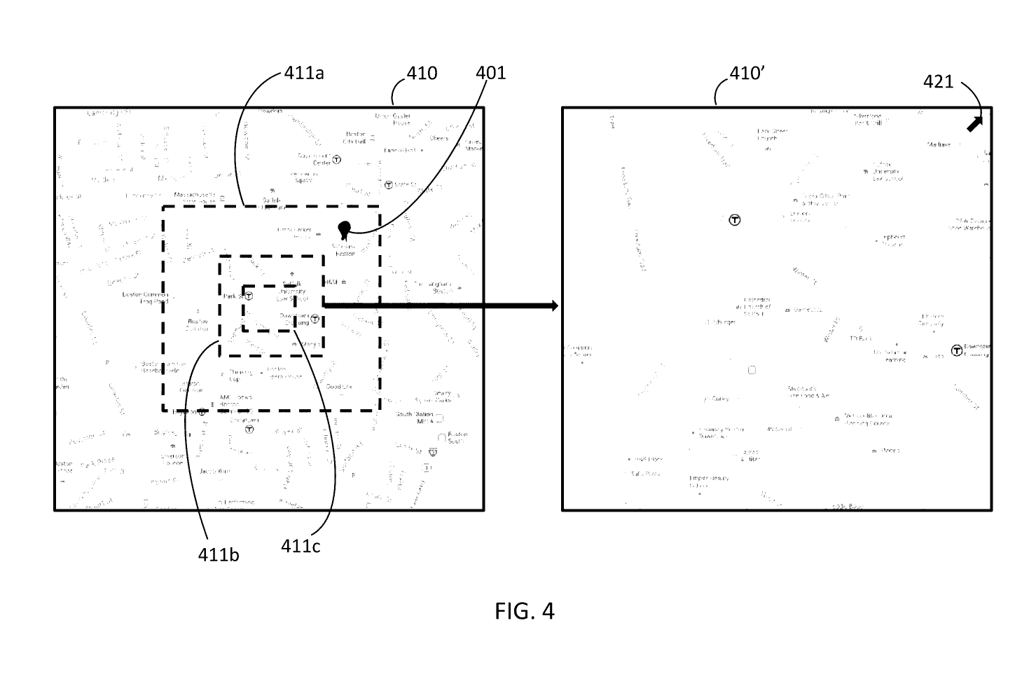

The computer device performing the process 300 is configured to use the performance data set associated with a set of in-viewport third content items to generate a use a training set for training a user interaction predictive model for off-viewport third party content items. The computer device selects an impression from the performance data set associated with an in-viewport third party content item and a respective first map viewport (stage 320). The impression indicates the number of times the third party content items was presented within the respective first map viewport. The respective first map viewport can be associated with a respective resolution level. The computer device then determines a second map viewport smaller than the first map viewport by a zoom level (stage 330). Specifically, the second map viewport is determined such that a location associated with the in-viewport third party content item falling inside the first map viewport falls outside the second map viewport. The determination of the second map viewport is further discussed below in relation to FIG. 4.

FIG. 4 shows a graphical diagram illustrating determination of a second map viewport based on a first map viewport and a location associated with a third party content item within the first map viewport, according to a described implementation. A first map viewport 410 associated with a respective resolution level can correspond to an impression indicative of a number of times a given third party content item was previously presented as in-viewport within the first map viewport 410. The first map viewport 410 includes a marker icon 401 indicative of the location associated with the third party content item within the firs map viewport. A number of virtual map viewports 411a-411c are smaller than, and share the same center with, the first map viewport 410. Each of the virtual map viewports 411a-411c is associated with a respective resolution level larger than that of the first map viewport 410. The virtual map viewports 411a-411c represent alternative map viewports for presenting the map related data associated with the first map viewport 410. For instance, if a user viewing the first map viewport 410 selects to zoom in the viewed map related data, one of the virtual map viewports 411a-411c will be selected based on a zoom level specified by input from the user and presented to the user instead of the first map viewport 410.

At stage 330 of FIG. 3, the computer device is configured to select a virtual map viewport smaller than the first map viewport 410 such that marker icon 401 is outside the selected virtual map viewport. For instance, the computer device can select the virtual map viewport 411b or 411c. In some implementations, the computer device can be configured to select the largest virtual map viewport 41 lb that is smaller than the first map viewport 410 and does not include the marker icon 401. In some implementations, the computer device can select one of the virtual map viewports 411b or 411c that is smaller than the first map viewport 410 and does not include the marker icon 401 according to one or more criteria. The selected virtual map viewport such as 41 lb can then be used as the second map viewport 410′ determined at stage 330 of the process 300 shown in FIG. 1. The third party content item indicated by the marker icon 401 would be presented as off-viewport if presented with the second map viewport 410′. In such a case, the third party content item can be indicated using a projective marker 421.

Referring back to FIG. 3, at stage 330 the computer device may fail to determine a second map viewport that does not include the third party content item. For instance, the first map viewport 410 can be associated with the highest resolution available and no zooming in can be performed. Alternatively, the third party content item may still fall within the second map viewport 410′ even when zooming in to the highest resolution available. If the computer device fails to determine a second map viewport (decision block 335), the computer device can ignore the current impression and select a new impression (stage 320). If the computer device succeeds to determine a second map viewport (decision block 335), the computer device can use the selected impression and the corresponding user interaction measurement(s) as an estimate of the performance of the third party content item as if it was presented off-viewport with the determined second map viewport 410′ (shown in FIG. 4). In other words, the selected impression can be used as an indication of a number of times the third party content item is hypothetically presented as off-viewport with the second map viewport 410′. The user interaction measurement corresponding to the selected impression can be used as an estimate of user interaction performance of the third party content item when hypothetically presented as off-viewport with the second map viewport 410′. If the computer device succeeds to determine a second map viewport (decision block 335), the computer device can be configured to add the selected impression, the corresponding user interaction measure, and an indication of the zoom level in a training data set (stage 340). The computer device is configured to loop through stages 320-340 until all impressions in the obtained data set are processed to construct the training data set (decision block 350). In other words, each impression in the obtained data set (or in a subset of the obtained data set) is added with the corresponding user interaction measure and the indication of the zoom level used to determine the second map viewport in the training data set. The indication of the zoom level includes a value representing a zoom level, a value representing a resolution level of the second map viewport, values representing the resolution levels of the first and second map viewports, and/or the like.

Upon constructing the training data set, the computer device can use the constructed data set to train a user interaction predictive model for predicting user interaction to off-viewport third party content items (stage 360). Specifically, the impressions and the indications of the zoom levels in the constructed data set can be fed as input to the user interaction predictive model. The user interactions measurements corresponding to the impressions in the constructed training data set can be used as benchmark outputs of the trained user interaction predictive model. During the training process, an output of the user interaction predictive model corresponding to a given impression and a respective zoom level as input can be compared to the user interaction measurement corresponding to the given impression and parameters of the trained user interaction predictive model can be adjusted based on the result of the comparison. In some implementations, other information such as user preferences, location profile information associated with a map viewport, distances between locations associated with third party content items and centers of respective map viewports, and/or other information can also be provided as input to the user interaction predictive model being trained. In some implementations, the user interaction predictive model can be implemented as a finite state machine, a hidden Markov model (HMM), a neural network (NN), a deep neural network (DNN), or any other model known to a person of ordinary skill in the art.

Once the user interaction predictive model is trained, the content item selection system 110 (shown in FIG. 1) can employ the trained user interaction predictive model to select third party content items to be presented as off-viewport with map related data (stage 370). Given a request for map related data from a client device 120 (shown in FIG. 1), the content item selection system 110 can select one or more third party content items to be presented off-viewport with the requested map related data. In some implementations, a map viewport can be specified for the requested map related data and the content item selection system 110 can use the trained user interaction predictive model to compute user relevance scores (or other scores) for multiple third party content items that can be presented as off-viewport with the specified map viewport. The content item selection system 110 can then select a subset of the multiple third party content items based on the computed relevance scores for presenting as off-viewport with the specified map viewport. In some implementations, the content item selection system 110 may not be aware of a specified map viewport associated with the requested map related data (the map viewport can be chosen at the requesting client device 120). In such case, the content item selection system 110 can assume one or more map viewports for the requested map related data. For each assumed map viewport, the content item selection system 110 can compute relevance scores for one or more respective third party content items that can be presented off-viewport with the assumed map viewport. The computed scores for each assumed map viewport can be provided to the resource server 104 (shown in FIG. 1) or the requesting client device 120 to be used in selecting and requesting third party content items based on a specified map viewport.

A person of ordinary skill in the art should appreciate that the process 300 can be executed by a single computer device such as a processor associated with the content item selection system 110 or can be executed by multiple computer devices. For instance, the construction of the training data set (stages 310-350) and the training of the user interaction predictive model can be executed offline by a first computer device while employing the trained user interaction predictive model (stage 370) can be executed by a second computer device such as a processor associated with the content item selection system 110.

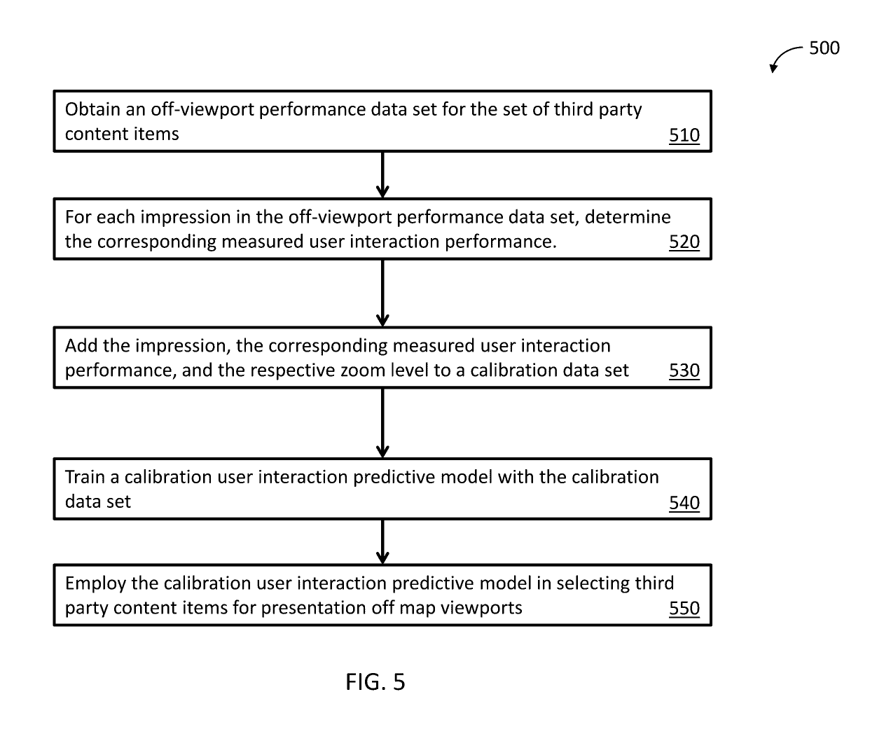

FIG. 5 is a flowchart illustrating a process 500 of generating and using a calibrated user interaction predictive model to select off-viewport third party content items. The process 500 includes obtaining an off-viewport performance data set associated with a set of third party content items (stage 510), determining a corresponding measured user interaction performance and a corresponding predicted user interaction performance for each impression in the obtained off-viewport performance data set (stage 520), adding each impression with the corresponding measured user interaction performance, the corresponding predicted user interaction performance (stage 530), and a respective zoom level to a calibration data set, using the calibration data set to train a calibrated user interaction predicted model (stage 540), and employing the trained calibrated user interaction predictive model to select third party content items for presenting off-viewport (stage 550).

Similar to the process 300 (shown in FIG. 3), the process 500 can be executed by one or more computer devices associated with the system 100 (shown in FIG. 1). A computer device of associated with system 100 can be configured to construct a calibrated user interaction predictive model based on an off-viewport performance data set. The computer device can be configured to obtain the off-viewport performance data set (stage 510). The off-viewport performance data set can include impressions and corresponding measured user interaction performances associated with a set of third party content items presented as off-viewport. In some implementations, each impression represents a number of times a third party content item was presented as off-viewport with a respective map viewport. The map viewport can be associated with a respective resolution level or a respective zoom level used in the process 300 to determine the map viewport. In some implementations, each impression represents a number of times a third party content item was presented as off-viewport and corresponds to one or more measure user interaction performance values associated with one or more respective map viewports. In some implementations, the set of third party content items is the same set of third party content items associated with the training data set obtained in the process 300 shown in FIG. 3 or a subset thereof. In some implementations, the set of third party content items presented as off-viewport can be different from the set of third party content items associated with the training data set obtained in the process 300.

The computer device can determine for each impression in the off-viewport performance data set a corresponding measured user interaction performance value (stage 320). The measured user interaction performance values can include CTR values, CVR values, or other user interaction performance values associated with third party content items presented as off-viewports. The measured user interaction performance values represents real user interaction performance data that can be collected during the deployment phase of the trained user interaction predictive model employed according to FIG. 3 (stage 370 of the process 300 in FIG. 3). In some implementations, the computer device can further determine a predicted user interaction performance value for each impression. The predicted user interaction performance values represent output values, associated with third party content items and respective map viewports, of the trained user interaction predictive model of FIG. 3.

The computer device can be configured to add the impressions in the off-viewport performance data set with the corresponding measured user interaction performance values and indications of corresponding zoom levels to a calibration data set (stage 530). For each impression associated with an off-viewport third party content item and a respective map viewport, the zoom level corresponds to the zoom level used in stage 330 of the process 300 to determine the map viewport. The indication of the zoom level includes a value representing a zoom level, a value representing a resolution level of the map viewport, and/or the like. The computer device can be further configured to add a corresponding predicted user interaction performance value (obtained from the trained user interaction model of FIG. 3) for each impression to the calibration data set.

Upon constructing the calibration data set by including impressions and corresponding user interaction performance values, the computer device can be configured to train a calibration user interaction predictive model with the calibration data set (stage 540). In some implementations, an impression from the off-viewport performance data set with the respective indication of the zoom level are provided as input to the calibration user interaction predictive model at each step of the training phase. In some implementations, the corresponding predicted user interaction performance value and/or other information such as indications of user preferences, the distance between the location associated with the third party content item and the center of the respective map viewport, can also be provided as input to the calibration user interaction performance model. The measured user interaction performance value corresponding to the impression is used as a benchmark output for the calibration user interaction predictive model. In other words, at each stage, the computer device compares the output of the calibration user interaction predictive model associated with an input impression to the corresponding measured user interaction performance value, and updates parameters of the calibration user interaction predictive model based on the result of the comparison. The calibration user interaction predictive model can be implemented as hidden Markov model (HMM), a finite state machine (FSM), a neural network (NN), a deep neural network (DNN), or any other model known to a person of ordinary skill in the art. In some implementations, the calibration user interaction predictive model is the trained user interaction model of FIG. 3 calibrated with the measure user interaction performance values. The calibration user interaction predictive model can be implemented as a linear or nonlinear regression model.

Upon training the calibration user interaction predictive model, the content item selection system 110 (shown in FIG. 1) can employ the calibration user interaction predictive model (for instance instead of the previously trained user interaction prediction model employed at stage 360 of FIG. 3) to select and provide third party content items for presentation as off-viewport with requested map related data. A person skilled in the art should appreciate that since the trained calibration user interaction predictive model is trained using measured real data, it provides improved prediction over the trained user interaction prediction model of FIG. 3 which is trained using hypothetical (or estimated) data.

A person skilled in the art should appreciate that processes described herein while described in relation to map related data, can be implemented with other types of data such as images associated with different resolution levels. For instances, images (such as photographs) of some locations can be presented with third party content items at different resolution levels. The third party content items can be presented off-viewport with the such images.

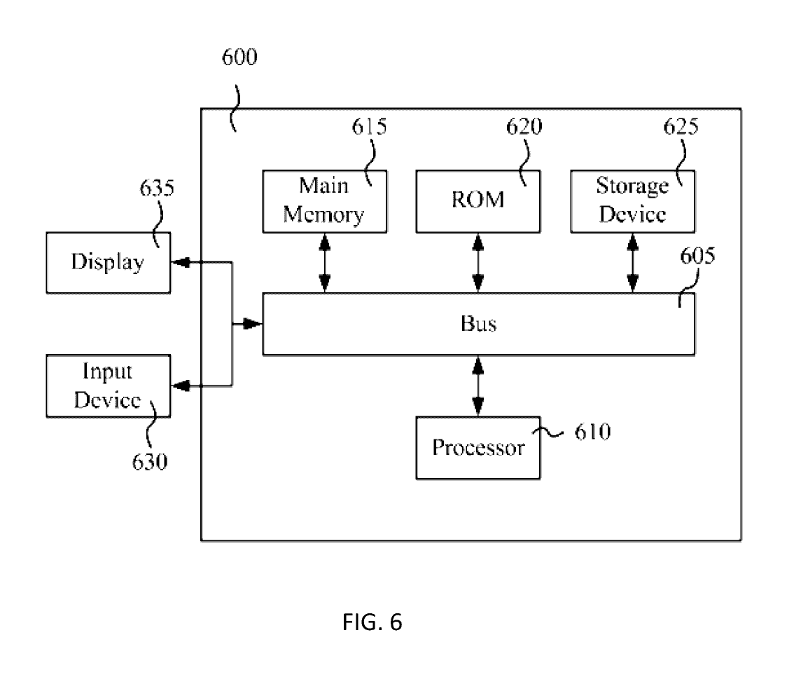

FIG. 6 is a block diagram of a computer system 600 that can be used to implement the client device 120, content item selection system 110, third-party content server 102, resource server 104, etc. The computing system 600 includes a bus 605 or other communication component for communicating information and a processor 610 coupled to the bus 605 for processing information. The computing system 600 can also include one or more processors 610 coupled to the bus for processing information. The computing system 600 also includes main memory 615, such as a RAM or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a ROM 620 or other static storage device coupled to the bus 605 for storing static information and instructions for the processor 610. A storage device 625, such as a solid state device, magnetic disk or optical disk, is coupled to the bus 605 for persistently storing information and instructions. Computing device 600 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 600 may be coupled via the bus 605 to a display 635, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 630, such as a keyboard including alphanumeric and other keys, may be coupled to the bus 605 for communicating information and command selections to the processor 610. In another implementation, the input device 630 may be integrated with the display 635, such as in a touch screen display. The input device 630 can include a cursor control, such as a mouse, a trackball, or cursor direction keys, for communicating direction information and command selections to the processor 610 and for controlling cursor movement on the display 635.

According to various implementations, the processes and/or methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes and/or method steps described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an implementation of a computing system 600 has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” or “processing circuit” encompass all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A method comprising:
obtaining an in-viewport performance data set including a plurality of impressions and a corresponding plurality of user interaction performance measures associated with a respective set of third-party content items, each impression being associated with a third-party content item of the set of third party content items presented for display in a respective first map viewport associated with a first resolution level;
determining for each impression a second map viewport associated with a second resolution level, the second map viewport being smaller than the first map viewport by a respective zoom level such that a location within the first map viewport associated with the third-party content item is outside the second map viewport;
generating a training data set including, the plurality of impressions, the corresponding plurality of user interaction performance values and indications of the corresponding zoom levels;
training a user interaction predictive model using the generated training data set; and
using the trained user interaction predictive model to select third party content items for presentation with respective second map viewports as off-viewport third-party content items.

2. The method of claim 1, wherein the set of third party content items is a set of advertisement content items.

3. The method of claim 1, wherein the user interaction predictive model is one of a predictive click through rate (pCTR) model and a predictive conversion rate (pCVR) model.

4. (canceled)

5. The method of claim 1 further comprising obtaining observation data associated with the set of third party content items, the observation data indicating impressions and corresponding user interaction performance measures of the third party content items presented as off-viewport third party content items.

6. The method of claim 5, wherein the generated training data set is a first training data set and the method further comprising generating a second training data set associated with the set of third party content items including the obtained observation data and the indications of the zoom levels.

7. The method of claim 6, wherein the user interaction predictive model is a first user interaction predictive model and the method further comprising:
training a second user interaction predictive model using the second training data set; and
using the trained second user interaction predictive model to select third party content items for presentation with respective second map viewports as off-viewport third party content items.

8. The method of claim 7, wherein the second training data set further includes outputs of the first user interaction predictive model.

9. The method of claim 7, wherein training the second user interaction predictive model includes estimating parameters of the second user interaction predictive model.

10. The method of claim 1, wherein training the first user interaction predictive model includes estimating parameters of the first user interaction predictive model.

11. A data processing system comprising:
a memory storing an in-viewport performance data set including a plurality of impressions and a corresponding plurality of user interaction performance measures associated with a respective set of third-party content items, each impression being associated with a third-party content item of the set of third party content items presented for display in a respective first map viewport associated with a first resolution level; and
a processor configured to:
determine for each impression a second map viewport associated with a second resolution level, the second map viewport being smaller than the respective first map viewport by a respective zoom level such that a location within the first map viewport associated with the third party content item is outside the second map viewport;
generate a training data set including the plurality of impressions, the corresponding plurality of user interaction performance values and indications of the corresponding zoom levels;
train a user interaction predictive model using the generated training data set; and
use the trained user interaction predictive model to select third party content items for presentation with respective second map viewports as off-viewport advertisements.

12. The data processing system of claim 11, wherein the set of third party content items is a set of advertisement content items.

13. The data processing system of claim 11, wherein the user interaction predictive model is one of a predictive click through rate (pCTR) model and a predictive conversion rate (pCVR) model.

14. (canceled)

15. The data processing system of claim 11, the processor is further configured to obtain observation data indicative of impressions and corresponding user interaction performance measures of the third party content items presented as off-viewport third party content items.

16. The data processing system of claim 15, wherein the generated training data set is a first training data set and the processor is further configured to generate a second training data set associated with the set of third party content items including the obtained observation data and the indications of the zoom levels.

17. The data processing system of claim 11, wherein the user interaction predictive model is a first user interaction predictive model and the processor is further configured to:
train a second user interaction predictive model using the second training data set; and
use the trained user interaction predictive model to select third party content items for presentation with respective second map viewports as off-viewport third party content items.

18. The data processing system of claim 17, wherein the second training data set further includes outputs of the first user interaction predictive model.

19. The data processing system of claim 17, wherein training the second user interaction predictive model includes estimating parameters of the second user interaction predictive model.

20. The data processing system of claim 11, wherein training the first user interaction predictive model includes estimating parameters of the first user interaction predictive model.

21. The data processing system of claim 11, wherein the data processing system includes a computer device.

22. A computer readable storage device storing instructions that, when executed by one or more processors, cause the one or more processors to perform operations comprising:
obtaining an in-viewport performance data set including a plurality of impressions and a corresponding plurality of user interaction performance measures associated with a respective set of third-party content items, each impression being associated with a third-party content item of the set of third party content items presented for display in a respective first map viewport associated with a first resolution level;
determining for each impression a second map viewport associated with a second resolution level, the second map viewport being smaller than the first map viewport by a respective zoom level such that a location within the first map viewport associated with the third-party content item is outside the second map viewport;
generating a training data set including, the plurality of impressions, the corresponding plurality of user interaction performance values and indications of the corresponding zoom levels;
training a user interaction predictive model using the generated training data set; and
using the trained user interaction predictive model to select third party content items for presentation with respective second map viewports as off-viewport third-party content items.
